(19) United States
(12) Patent Application Publication
(10) Pub. No.: US 2026/0313425 A1
(43) Pub. Date: Oct. 8, 2026

(54) USER EQUIPMENT PROCESSING METHOD

(71) Applicant: ZTE CORPORATION, Shenzhen, Guangdong (CN)

(72) Inventors: Guozeng ZHENG, Shenzhen (CN); Zhaohua LU, Shenzhen (CN); Wenfeng LIU, Shenzhen (CN); Huahua XIAO, Shenzhen (CN); Lun LI, Shenzhen (CN); Yong LI, Shenzhen (CN)

(21) Appl. No.: 19/483,385

(22) PCT Filed: May 15, 2023
(86) PCT No.: PCT/CN2023/094302

§ 371 Date: Nov. 11, 2025

(51) Int. Cl. H04W 24/10

(52) U.S. Cl. CPC H04W 24/10

(57) ABSTRACT

A wireless communication method is provided, and includes: reporting, by a wireless communication device, feature information for a feature in a user equipment (UE) capability report.

### CROSS-REFERENCE TO RELATED APPLICATION(S)

The present disclosure is a national phase entry under 35 USC 371 of International Patent Application No. PCT/CN2023/094302 filed on May 15, 2023, and the entire content of the International Patent Application is incorporated herein by reference.

### TECHNICAL FIELD

This document is directed generally to wireless communications. More specifically, a user equipment (UE) device may have a processing method or functionality for improved communication or processing.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, improvements should be made to maintain and ensure the quality of service standards.

### SUMMARY

This document relates to methods, systems, and devices for a user equipment (UE) device to have a processing method or functionality for improved communication or processing. Beam information prediction, channel information prediction, channel information compression, channel demodulation, or positioning may be improved with a processing method. Supported functionalities or conditions may be reported by the UE for particular features. The report may be a UE capability report. The UE may support processing method or model identifiers (IDs) for the feature that are included in the report. The processing method may be used for management reporting, performance monitoring, activation, switching, and/or selection.

In one embodiment, a wireless communication method includes reporting, by a wireless communication device, feature information for a feature in a user equipment (UE) capability report.

In another embodiment, a wireless communications apparatus comprises a processor and a memory, and the processor is configured to read code from the memory and implement any of the embodiments discussed above.

In another embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example base station.

FIG. 2 shows an example random access (RA) messaging environment.

FIG. 3 shows an embodiment of a wireless network system architecture.

FIG. 4 shows an example artificial intelligence (AI) model or processing method.

FIG. 5 shows example features to use the processing method or model.

FIG. 6 shows an example reporting of supported functionalities for a feature from user equipment (UE) to the network.

FIG. 7 shows an example reporting of supported conditions for a feature from user equipment (UE) to the network.

FIG. 8 shows an example reporting of supported functionality identifiers or model identifiers for a feature from user equipment (UE) to the network.

FIG. 9 shows an example functionality or processing method management.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

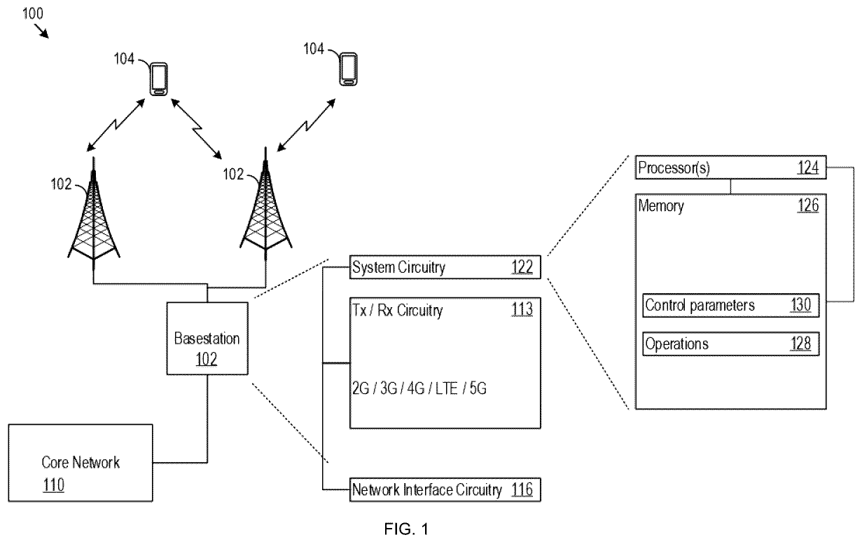

FIG. 1 shows an example basestation 102. The basestation 102 may also be referred to as a wireless network node or a next generation radio access network (“NG-RAN”) node. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the base station. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

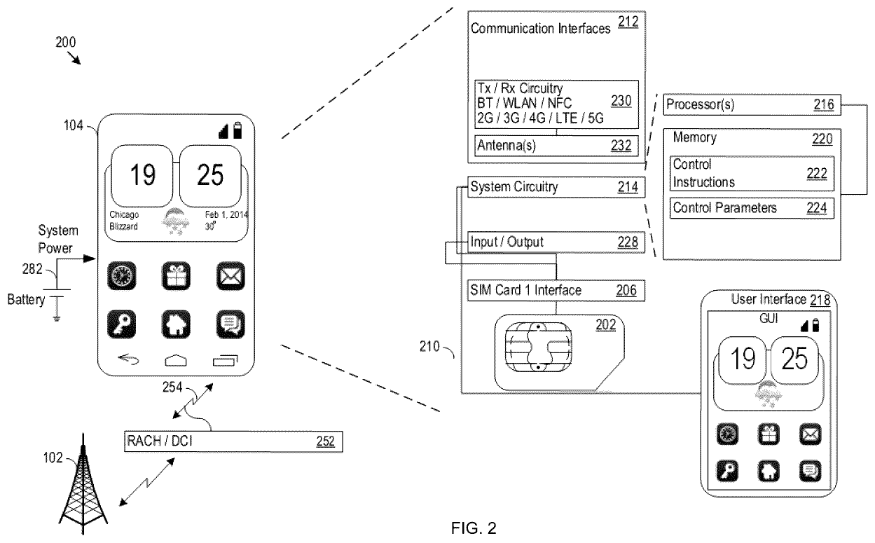

FIG. 2 shows an example random access messaging environment 200. In the random access messaging environment, a UE 104 may communicate with a base station 102 over a random access channel 252. In this example, the UE 104 supports one or more Subscriber Identity Modules (SIMs), such as the SIM1 202. Electrical and physical interface (also referred to as SIM Card 1 Interface) 206 connects SIM1 202 to the rest of the user equipment hardware, for example, through the system bus 210.

The mobile device 200 includes communication interfaces 212, system logic (also referred to as System Circuitry) 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the Input/Output 228 may include a graphical user interface, touch sensitive display, haptic feedback or other haptic output, voice or facial recognition inputs, buttons, switches, speakers and other user interface elements. Additional examples of the Input/Output 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

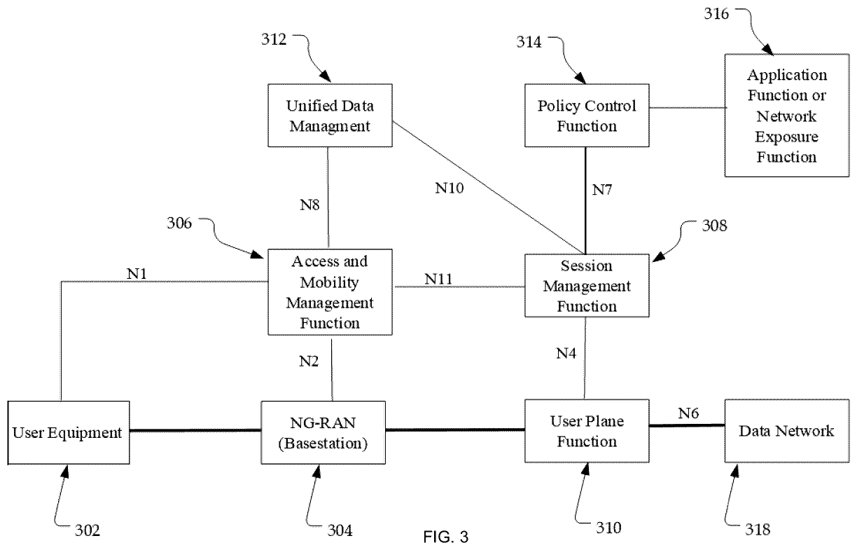

FIG. 3 shows one embodiment of a wireless network system architecture. This architecture is merely one example and there may be more or fewer components for implementing the embodiments described herein. The interconnections or communications between components are identified as N1, N2, N4, N6, N7, N8, N10, and N11, which may be referred to in the description or by other Figures. FIG. 3 illustrates an example user equipment (“UE”) 302. UE 302 is a device accessing a wireless network (e.g., 5GS) and obtaining service via an NG-RAN node or basestation 304. The UE 302 interacts with an Access and Mobility Management Function (“AMF”) 306 of the core network via NAS signaling. FIG. 3 illustrates an example basestation or NG-RAN 304. The basestation 304 may also be referred to as a next generation radio access network (“NG-RAN”) node and can provide a time synchronization signal to user equipment (UE). There may be an Al model or processing method that is part of the UE 302 and information may be provided by the UE to components shown in FIG. 3 as described in the embodiments below.

The AMF 306 includes the following functionalities: Registration management, Connection management, Reachability management and Mobility Management. The AMF 306 also performs the access authentication and access authorization. The AMF 306 is the NAS security termination and relays the session management NAS between the UE 302 and the SMF 308, etc. The SMF 308 includes the following functionalities: Session Management, e.g., Session establishment, modify and release, UE IP address allocation & management (including optional Authorization), Selection and control of uplink function, downlink data notification, etc. The user plane function (“UPF”) 310 includes the following functionalities: Anchor point for Intra-/Inter-RAT mobility, Packet routing & forwarding, Traffic usage reporting, QoS handling for user plane, downlink packet buffering and downlink data notification triggering, etc. The Unified Data Management (“UDM”) 312 manages the subscription profile for the UEs. The subscription includes the data used for mobility management (e.g., restricted area), session management (e.g., QoS profile). The subscription data also includes slice selection parameters, which are used for AMF 306 to select a proper SMF 308. The AMF 306 and SMF 308 get the subscription from the UDM 312. The subscription data may be stored in a Unified Data Repository with the UDM 312, which uses such data upon reception of request from AMF 306 or SMF 308. The Policy Control Function (“PCF”) 314 includes the following functionality: supporting a unified policy framework to govern network behavior, providing policy rules to control plane function(s) to enforce the policy rule, and implementing a front end to access subscription information relevant for policy decisions in the User Data Repository. The Network Exposure Function (“NEF”) 316 is deployed optionally for exchanging information with an external third party. In one embodiment, an Application Function (“AF”) 316 may store the application information in the Unified Data Repository via NEF. The UPF 310 communicates with the data network 318.

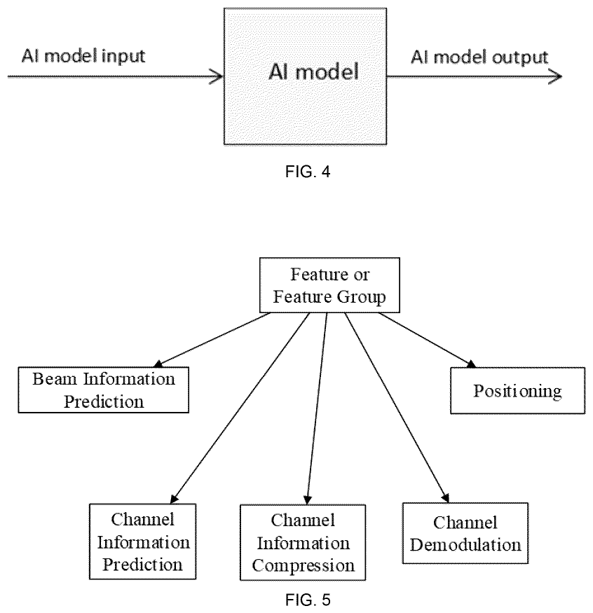

FIG. 4 shows an example artificial intelligence (AI) processing method. AI may also be referred to as Machine Learning (ML). In embodiments described below, the wireless communication system of FIGS. 1-3 may be improved with increased efficiency. For example, AI/ML may be used to increase the accuracy of channel state information (CSI). In addition, AI/ML may also predict beam information in spatial domain or time domain. Other examples may include but are not limited to: channel information compression, channel information predication, channel demodulation, positioning. In order to support physical layer examples with AI/ML, the UE may be deployed with processing methods (e.g., the processing methods refer to AI/ML models). In other words, the processing method shown in FIG. 4 may be part of the UE in some embodiments. The network (e.g., base station or other components in FIG. 3 other than UE) may receive certain the information about UE's processing. The information may be referred to as feature information and may be needed for proper configuration for wireless communication using the processing method. The AI/ML processing method may allow the network to configure the necessary information according to the feature information for a corresponding processing method/functionality/model. In some embodiments, the UE's processing may include the processing method for various features/examples that are communicated between the UE and the network.

The Artificial Intelligence/Machine Learning (AI/ML) processing method in FIG. 4 is a data driven algorithm that applies AI/ML techniques to generate a set of outputs based on a set of inputs. As shown, there may be a processing method input, which includes the data fed into the processing method. There may be a processing method output, which includes the output of the processing method. The processing method may include an algorithm to derive the relationship between the processing method input and processing method output. The algorithm may include a processing method structure and/or processing method parameters. The processing method structure includes the description of the functions used in each layer of the processing method and the processing method parameters include variables/weights of the functions. The processing method may fit input into the processing method to get an expected output or prediction.

In the following embodiments, the processing method may also include (or be referred to as) a functionality, an AI/ML model, or a feature. It may include when a UE is capable of doing a specific functionality, processing method, an AI/ML model, or a feature. In some embodiments, the processing method may only apply for certain environments and this may be referred to generalization, where good generalization suggests that the processing method can be used in more environments or examples.

FIG. 5 shows example features for use cases using the processing method. In some embodiments, the feature (or a feature group) in the processing method may refer to the examples/cases shown in FIG. 5 and include information about each feature. The processing method may be used for each of these to get an output, such as making a prediction. As a first example, beam information prediction may use the measured beams to predict unmeasured beams. Beam information may include the position of a UE. This may also be referred to as serving beam measurement configuration and may include an indication to request reporting of reference signals. In another example, serving beam measurement configuration may include an indication to request reporting of one or more reference signals serving the UE in a period of time. In another example, serving beam measurement configuration may include an indication to request reporting the UE staying time in each reported reference signal.

For simplicity, the feature described below may be for beam information, but that is merely one example and may apply to other examples, including a few mentioned below. As a second example, channel information prediction may include using the measured channels to predict unmeasured channels. As a third example, channel information compression may include using a processing method to compress the channel in order to reduce feedback overhead. As a fourth example, channel demodulation may include using a processing method to demodulate data from various impairments. As a fifth example, positioning may include using a processing method to infer a UE location or location related information (e.g., timing information or angle information).

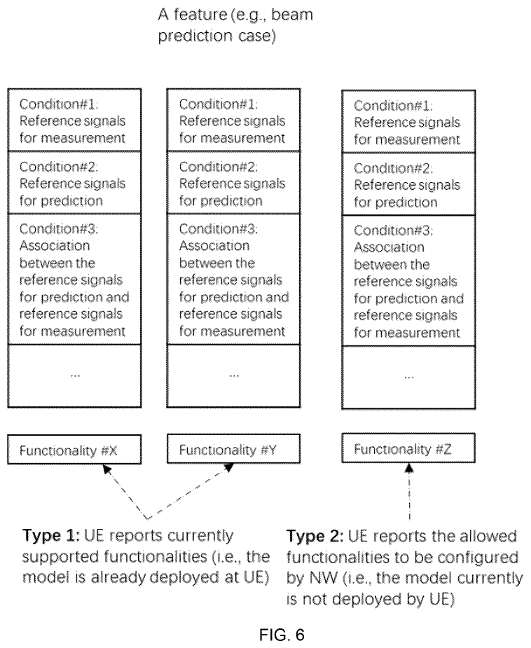

FIG. 6 shows an example reporting of supported functionalities for a feature from user equipment (UE) to the network. The UE reports its supported functionalities for a feature to the network (NW). The reporting may be referred to as feature information that is reported in a UE capability report. The NW may include the base station or other components shown in FIG. 3. In a Type 1, the processing method associated with the supported functionality is already deployed at the UE. Alternatively, the supported functionality is available (e.g., ready to be used/activated) after the reporting of the feature information. In some embodiments, the functionality can be activated after the UE receives the signaling from the NW, where the signaling may be RRC, MAC CE or DCI. For the Type 2, the processing method is not yet deployed by the UE. Alternatively, the functionality is not available (e.g., not ready to be used/activated). As described, the UE may report its supported functionalities for a feature (i.e., feature information) to the NW. In some embodiments, the supported functionalities for a feature are reported in a UE capability report. Specifically, the UE may report on functionalities X, Y, or Z as shown in FIG. 6. The functionality may be a processing method or how the processing method is deployed under the functionality. A feature may also refer to a use case, such as those shown with respect to FIG. 5.

In some embodiments, each functionality may be associated with a plurality of conditions that are used to describe the applicability information of the functionality. For each functionality, there may be multiple conditions. In some embodiments, different functionalities may be associated with the same or different conditions. In some embodiments, the conditions are to indicate the applicable parameters, scenarios, regions, and/or datasets of the functionality. For example, the processing method or model deployed for the functionality may have a generalization status or issue. The generalization may be a measure of how generalized the processing method is and how specific it can be for making predictions or determinations. In other words, the processing method or model may work in the parameter, scenario, region, or dataset that is used for initializing and training the processing method. A condition may include a parameter, a scenario, a region or a dataset to which the processing method or functionality can be applied. In some embodiments, only the applicable parameters are reported in a UE capability report. The applicable scenarios, regions and/or datasets are reported after the UE capability report.

A parameter may include necessary/required configuration from the network to apply the processing method or functionality. This may be referred to as network configuration. The configuration is according to the specific parameters under which the functionality or the processing method can work. For the beam information prediction example of FIG. 5, there may be a variety of example parameters that include at least one of:
Frequency band;
Carrier frequency;
Bandwidth;
Sub-carrier spacing;
Reference signals for prediction;
Reference signals for measurement;
Association between the reference signals for prediction and reference signals for measurement;
Number of beams to be reported to NW;
Number of historical time instances for temporal beam prediction;
Number of future time instances for temporal beam prediction;
Number of beams to be reported to NW for a time instance for temporal beam prediction; or
Periodicity of reference signal.

For the channel information predication example of FIG. 5, there may be a variety of example parameters that include at least one of:
Frequency band;
Carrier frequency;
Bandwidth;
Sub-carrier spacing;
Reference signals for prediction;
Reference signals for measurement;
Association between the reference signals for prediction and reference signals for measurement;
Number of time instances to be reported to NW;
Number of historical time instances for temporal beam prediction;
Number of future time instances for temporal beam prediction;
The codebook type to report the channel in future time instances; or
Periodicity of reference signal.

For the channel information compression example of FIG. 5, there may be a variety of example parameters that include at least one of:
Frequency band;
Carrier frequency;
Bandwidth;
Sub-carrier spacing;
Reference signals for measurement;
The number of subbands (or the number of subbands as an input to a processing method);
The granularity of a subband (e.g., by indicating the number of PRBs in a subband);
The number of antenna ports (or the number of antenna ports as an input to a processing method);
The number of layers (or the number of layers as an input to a processing method);
Pairing ID (which indicates the pairing information of a processing method at UE for channel information compression and another processing method at network for channel information de-compression);
The payload size (e.g., the compressed channel should be reported to network, the payload size refers to the reported overhead needed for the compressed channel. The payload size is related to the output of the processing method. One processing method may support multiple payload sizes); or
Quantization method (e.g., the method for scalar quantization or the method for vector quantization, which refers to how to quantize the compressed channel to be reported).

For the channel demodulation example of FIG. 5, there may be a variety of example parameters that include at least one of:
Frequency band;
Carrier frequency;
Bandwidth;
Sub-carrier spacing;
Reference signals for measurement;
The number of subbands (or the number of subbands as an input to a processing method);
The granularity of a subband (e.g., by indicating the number of PRBs in a subband);
The number of antenna ports (or the number of antenna ports as an input to a processing method);
The number of layers (or the number of layers as an input to a processing method);
The number of symbols for a data channel (e.g., PDSCH); or
The time gap between the reference signaling and the data channel.

For the positioning example of FIG. 5, there may be a variety of example parameters that include at least one of:
Frequency band;
Carrier frequency;
Bandwidth;
Sub-carrier spacing;
Reference signals for measurement;
The number of antenna ports (or the number of antennas as an input to a processing method);
The TRP (Transmission Reception Point) identifier(s);
Input measurement type (e.g., power delay profile (PDP), channel impulse response (CIR) as input to the processing method);
Number of paths (e.g., the number of paths (or delay taps) as the input to the processing method);
The granularity of the path (e.g., the time gap between two consecutive paths (or delay taps));
Output measurement type (e.g., as the output of the processing method):
   UE location;
   Time of flight (TOF): The propagation time between a UE and a TRP over the air;
   Light-of-sight indicator: The confidence level of a link between a TRP and a UE being light-of-sight;
   Angle information: e.g., angle of arrival, angle of departure; or
   Reference signal time difference (RSTD): relative timing difference between two TRPs.

The conditions for the applicable scenario may include at least one of:
Physical cell identification (PCI) through which a processing method or a functionality only works for a particular scenario such as a physical cell;
Cell Global Identity (e.g., NR Cell Global Identity (NCGI)); or
An identifier (ID) for a scenario. This may also be referred to as an implementation/categorization ID, which may implicitly indicate some implementations of the NW or UE. For example, it may refer to a specific NW antenna height, NW antenna layout, NW antenna radiation pattern, or NW antenna down tilt angle. The antenna information may be private information that is not shared, so it can be virtualized by this ID.

The conditions may be for an applicable region that may at least include the region ID. For example, it may refer to a geographical area. One cell may be divided into multiple regions, and each region may be identified with a region ID. In another example, indoor and outdoor may have different region IDs. There may be certain regions that are required for a particular processing method. Each region may be defined by each ID.

The conditions for an applicable dataset may at least include a dataset ID. It may refer to the data samples used for initializing or training the processing method or the functionality. Specifically, the AI/ML processing method is a data-driven method, which may only be applied to the data that has a similar distribution or relevance as the data used for processing method training. In other words, the processing method may be trained based on the data and may then only be applied to a new environment that has a similar data state as what was used for training.

The types were discussed above. Example embodiments for Type 2 are described below. In some embodiments, only after the processing method associated with a particular functionality is downloaded or transferred from other entity, the functionality can be available, used or activated. In some embodiments, the UE reports to the NW that the functionality can be used or activated (or available). For example, the processing method associated with a particular functionality may be downloaded after reporting of the UE capability report. In this case, the functionality is available after reporting of the UE capability report. In some embodiments, the NW requests that the UE download a processing method associated with the particular functionality. In addition, the request signaling may include a processing method/model ID that is indicated or linked to a processing method that the NW expects the UE to download. Moreover, UE may send confirmation information to the network that the corresponding processing method/model has been downloaded/deployed.

In some embodiments, the UE requests that the NW transfer a processing method associated with the functionality to the UE. In some embodiments, the request signaling may include a processing method/model ID that is indicated or linked to the processing method that the UE expects the NW to transfer. In some embodiments, the UE can indicate its supported processing method/model structure to the NW. Based on this indication, the NW may only transfer the processing method that has the same or similar processing method structure as indicated by the UE. Further, the NW may only transfer the corresponding processing method parameters to the UE. In some embodiments, the UE may indicate its supported processing method description languages (e.g., pytorch or tensorflow).

In some embodiments, the UE may indicate its supported storage information and/or computation complexity information about the processing method, which may include that the storage information may be related to the number of processing method parameters in a processing method, and/or the number of bits to quantize a processing method parameter. Alternatively, the computation complexity information may be related to the operation complexity of the processing method operated in a single time (e.g., the number of floating-point operations).

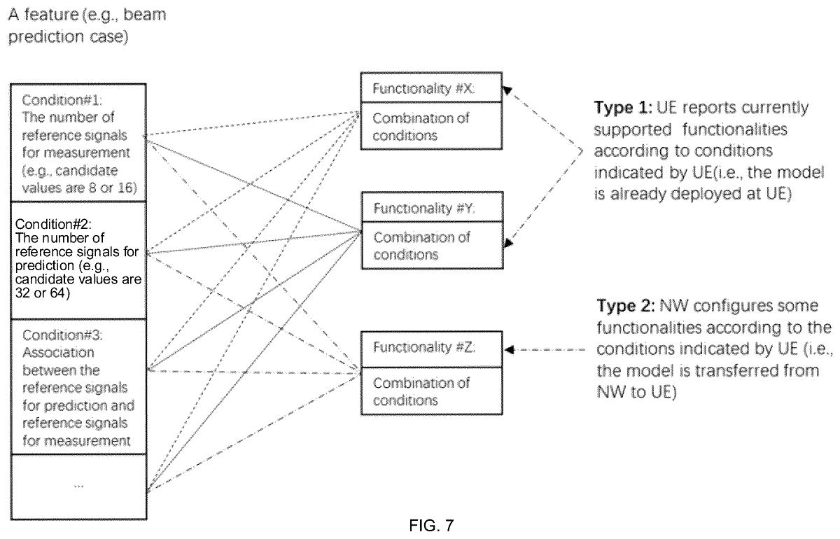

FIG. 7 shows an example reporting of supported conditions for a feature from user equipment (UE) to the network. In this example, the UE reports its supported conditions for a feature to the NW. As described above, content that is reported may be referred to as feature information. On the left of FIG. 7, the UE reports multiple conditions (e.g., applicable parameters, scenarios, regions or datasets as discussed above). In the middle of FIG. 7, there may be the report with supported functionalities after the reporting of the feature information. The report may include reported conditions and/or selected conditions to be associated with the functionality. In some embodiments, the UE reports its supported conditions for a feature to NW in a UE capability report. In some embodiments, the conditions are to indicate the applicable parameters, scenarios, regions, and/or datasets when a functionality is deployed or implemented at the UE. Each of the conditions includes at least one candidate value. In some embodiments, the functionality can either be reported by the UE or configured by the NW after the report of the feature information. In some embodiments, each functionality may include multiple (or a combination of) conditions that are to indicate the applicability information of the functionality including the applicable parameters, scenarios, regions, and/or datasets of the functionality, which should be according to the conditions included in the feature information. Each of the conditions of the functionality may include at least one candidate value of the condition. For example, in the feature information report, one condition is the number of reference signals for measurement. There are two candidate values: 8 or 16. Therefore, if this condition is indicated in a functionality, at least one candidate value of the condition should be indicated. In some embodiments, more than one candidate value can be indicated in a functionality. For example, the processing method of a functionality is capable of working in multiple environments by indicating multiple candidate values of a condition.

In some embodiments, the functionality includes two types. The types were also described with respect to FIG. 6. In type 1, supported functionalities without the processing method are transferred from the NW. Alternatively, the functionality is available (e.g., ready to be used or activated) after the reporting of the supported functionality. This may be when the processing method of the functionality is already deployed at the UE. The UE reports its supported functionalities and corresponding conditions associated with the functionalities. In addition, each of the conditions of the functionality includes at least one candidate value of the condition according to the report of the conditions by the UE. In some embodiments, the UE reports its supported functionalities after the UE capability report. In some embodiments, the functionality can be activated after the UE receives the signaling from the NW, where the signaling may be RRC, MAC CE or DCI.

In type 2, the supported functionalities with the processing method are transferred from the NW. Alternatively, the functionality is configured by network (e.g., the processing method of the functionality is transferred from network). This may be similar to type 2 with respect to FIG. 6. The processing method should be transferred from the network. Applicability information of the functionality (e.g., a combination of conditions) is provided by the network. In some embodiments, the processing method associated with the functionality is transferred from the NW. In addition, the NW provides the corresponding conditions associated with the functionality. Each of the conditions of the functionality may include at least one candidate value of the condition according to the report of the conditions by the UE. In some embodiments, the UE may report to the network that the UE is not able to implement and/or deploy the functionality/processing method. For example, when the UE cannot deploy the processing method transferred from the NW. In some embodiments, the UE may report that the functionality can be available (or ready to be used and/or activated) after the processing method is received.

In some embodiments, the NW requests that the UE download a processing method associated with a functionality. The request signaling may include a processing method/model ID that is indicated and/or linked to a processing method that the NW expects the UE to download. In addition, the NW provides the corresponding conditions associated with the functionality. Each of the conditions of the functionality includes at least one candidate value of the condition according to the report of the conditions by the UE.

In some embodiments, the UE requests that the NW transfer a processing method associated with the functionality to the UE. The UE may provide the corresponding conditions associated with the functionality. Each of the conditions of the functionality includes at least one candidate value of the condition according to the report of the conditions by the UE. In some embodiments, the request signaling may include a processing method/model identification (ID) that is indicated and/or linked to a processing method that the UE expects the NW to transfer. In some embodiments, the UE can indicate its supported processing method structure to the NW. The NW may only transfer the processing method that has the same or similar processing method structure as indicated by the UE. In addition, the NW may only transfer the corresponding processing method parameters to the UE. In some embodiments, the UE may indicate its supported processing method description languages (e.g., pytorch or tensorflow).

In some embodiments, the UE can indicate its supported storage information and computation complexity information about the processing method. This information may include the storage information that may be related to the number of processing method parameters in a processing method, and/or the number of bits to quantize a processing method parameter. This may further include the computation complexity information related to the operation complexity of the processing method operated in a single time (e.g., the number of floating-point operations).

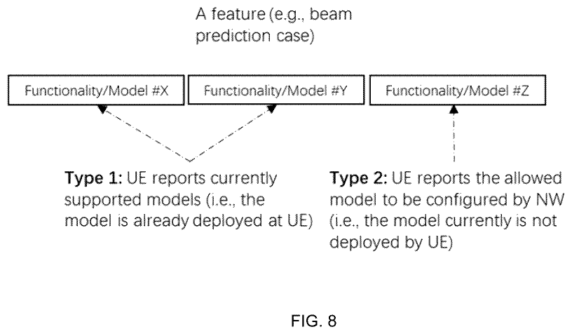

FIG. 8 shows an example reporting of supported functionalities or processing method/model identifiers for a feature from user equipment (UE) to the network (NW). As described, content that is reported may be referred to as feature information. The UE reports its supported functionality or processing method/model identifiers (IDs) for a particular feature to the NW. The processing method may already be stored at the network NW, so the NW has information on applicability information (e.g., the conditions) of the corresponding processing method. The UE reports its supported functionality IDs or processing method/model IDs for a feature to the NW in a UE capability report. In some embodiments, a functionality or processing method, including the conditions (e.g., applicable parameters, scenarios, regions and/or datasets) and/or the processing method associated with the functionality, may already be stored/registered/identified at the NW. Each of the functionalities or processing methods has been assigned with an ID to identify it. The UE can report functionality or processing method/model IDs to the NW. The NW can then know the functionality or processing method when checking with the corresponding functionality or processing method/model ID.

In some embodiments, the feature information report includes two types. The types were also described with respect to FIG. 8. In type 1, the processing method associated with the processing method/model ID is already deployed and/or implemented at the UE. Alternatively, the processing method indicated in the processing method ID is available (e.g., ready to be used/activated). In some embodiments, the functionality or processing method can be activated after the UE receives the signaling from NW, where the signaling may be RRC, MAC CE or DCI. For type 2, the processing method associated with processing method/model ID is not yet deployed/implemented at the UE. Alternatively, the processing method indicated in the processing method ID is not available (e.g., not ready to be used/activated). In some embodiments, only after the processing method associated with processing method/model ID is downloaded or transferred from another entity, then the functionality or the processing method can be available (used or activated). In some embodiments, the UE reports to NW that the functionality or processing method can be available/used/activated. For example, the processing method associated with the processing method ID is downloaded after reporting of the UE capability report. In some embodiments, the NW requests the UE to download a processing model associated with the functionality or processing method/model ID. In some embodiments, the UE requests that the NW transfer a processing method associated with the functionality or processing method/model ID to the UE. In some embodiments, the request signaling can include a processing method/model ID that is indicated or linked to a processing method that the UE expects the NW to transfer. In some embodiments, the UE can indicate its supported processing method structure to the NW. The NW may only transfer the processing method that has the same or similar processing method structure as indicated by the UE. The NW may only transfer the corresponding processing method parameters to UE according to the processing method structure. In some embodiments, the UE may indicate its supported processing method description languages (e.g., pytorch or tensorflow).

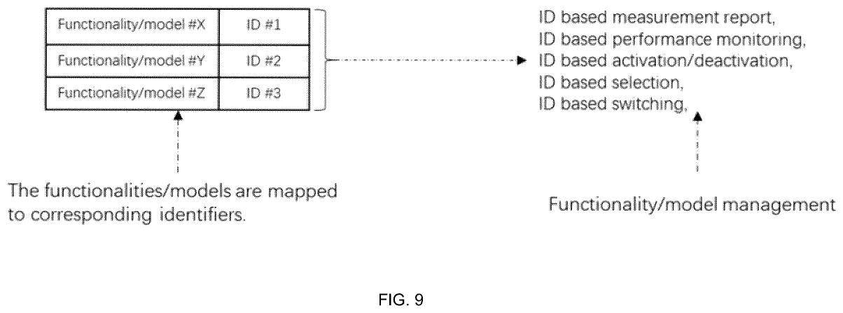

FIG. 9 shows an example functionality and processing method management. As described, a functionality (e.g., may be associated with a processing method) or a processing method is mapped to an identifier (ID). In some embodiments, the identifier is determined by the NW configuration. The functionality/processing method may be assigned with an identifier by the NW. The network may assign the ID and the UE may use the identifier to do management report or performance monitoring based on the corresponding functionality/processing method. The processing methods may be switched using the IDs. In some embodiments, either a functionality and/or a processing method may be mapped to an identifier. In some embodiments, the identifier may be determined by a UE report. For example, when the UE reports its supported functionalities/processing methods, the UE may also report the identifier for each functionality/processing method. Another, the identifier may be implicitly determined by the reporting order/sequence of the functionalities/processing methods by the UE.

In some embodiments, the identifier is unique within a specific, feature, a specific feature group, or a use case. In some embodiments, the identifier may be across multiple features (or feature groups). For example, the identifier may be unique within an RRC configuration. In some embodiments, the identifier may be associated with a measurement report (e.g., CSI report or beam report). For example, in a measurement configuration from the network, the network can indicate the functionality/processing method to acquire corresponding measurement report by indicating the corresponding identifier. In another example, the UE can provide feedback with a measurement report and indicate the functionality/processing method to acquire corresponding measurement report by indicating the corresponding identifier.

In some embodiments, the identifier may be associated with a performance monitoring procedure. For example, because of the generalization of a processing method, the processing method may not be able to perform properly in a new environment (if the processing method is not general enough). Therefore, the NW may initiate a performance monitoring procedure for a functionality/processing method. In this performance monitoring procedure, the UE may need to report the performance status of the functionality/processing method. The performance status may include some metrics related to the processing method prediction accuracy. The corresponding identifier may be associated with the performance monitoring procedure.

In some embodiments, the identifier is associated with an activation/deactivation command to activate/deactivate the processing method or the functionality. For example, the NW can use the identifier to activate/deactivate a functionality or processing method. In some embodiments, the UE can send a request to the NW in order to activate/deactivate a functionality or processing method by indicating the corresponding identifier. Alternatively, UE can send an indication to the NW that a functionality or a processing method is not available/applicable (or not ready to be used/activated) by indicating the corresponding identifier. In some embodiments, the activation/deactivation command can be a MAC CE or DCI signaling. In some embodiments, the identifier is associated with a selection command for selecting one or multiple functionalities or processing methods that are able to be activated. For example, the NW can use the identifiers to select one or multiple functionalities or processing methods for the activation purpose. In some embodiments, a functionality/processing method can be activated only when the functionality/processing method is selected in the selection command. In some embodiments, the selection command can be a MAC CE or DCI signaling. In some embodiments, the second identifier is associated with a switching command for switching from a processing method or a functionality to a different processing method or a different functionality. For example, the NW can use the identifiers to switch between one functionality or processing method to a different functionality or a processing method. For example, in a control signaling, the NW indicates to the UE to deactivate a functionality or processing method by one identifier and activate another functionality or processing method by another identifier. In some embodiments, the switching command can be a MAC CE or DCI signaling. In some embodiments, the bit width of signaling for the activation/deactivation command, selection command or switching command is fixed or related to the number of identifiers (e.g., the total number of functionalities and/or processing methods).

In some embodiments, the NW configures the necessary resource setting and/or a report setting according to the conditions associated with the corresponding functionalities or processing methods. Each resource setting may include a configuration of a list of reference signals. It may be for a measurement report or performance monitoring based on a functionality or processing method. Each report setting is associated with at least resource setting (e.g., for channel/interference measurement) and contains the parameter(s) for one measurement report. The parameter(s) may include codebook configuration (e.g., codebook subset restriction, time-domain behavior, frequency granularity for CQI and PMI, measurement restriction configurations, and the CSI-related quantities to be reported by the UE such as the layer indicator (LI), L1-RSRP, L1-SINR, CRI, and SSBRI (SSB Resource Indicator)). The functionality or processing method may be associated with the report setting by indicating the corresponding identifier.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium”, “machine readable medium”, “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additionally, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A wireless communication method, comprising:
reporting, by a wireless communication device, feature information for a feature in a user equipment (UE) capability report.

2. The method of claim 1, wherein the feature information comprises a supported functionality for the feature.

3. The method of claim 2, wherein the supported functionality is associated with a plurality of conditions with applicability information of the supported functionality; or
the supported functionality is available after the reporting of the feature information; or
receiving, by the wireless communication device, a processing method corresponding to the supported functionality.

4. The method of claim 3, wherein the conditions indicate at least one of parameter information, scenario information, region information, or data information of the supported functionality; or
the conditions comprise at least one of a candidate value of a parameter, a categorization identifier, a region identifier, or a dataset identifier.

5-7. (canceled)

8. The method of claim 3, wherein the supported functionality is available after the receiving of the processing method.

9. The method of claim 1, wherein the feature information comprises a plurality of conditions for the feature.

10. The method of claim 9, wherein each one of the plurality of conditions comprises at least one candidate value.

11. The method of claim 1, further comprising:
reporting, by the wireless communication device, the feature information comprises a plurality of conditions.

12. The method of claim 11, further comprising:
reporting, by the wireless communication device, a supported first functionality for the feature after the reporting of the feature information.

13. The method of claim 12, wherein the supported first functionality is associated with applicability information of the first functionality according to the plurality of the conditions; or
the supported first functionality is available after the reporting of the supported first functionality.

14. (canceled)

15. The method of claim 9, further comprising:
receiving, by the wireless communication device, a configuration of a second functionality, wherein the configuration comprises applicability information of the second functionality according to the plurality of the conditions.

16. The method of claim 15, further comprising:
receiving a processing method associated with the second functionality.

17. The method of claim 16, wherein the second functionality is available after the receiving of the processing method.

18. The method of claim 1, wherein the feature information comprises a first identifier associated with a processing method.

19. The method of claim 17, wherein the processing method is available after the reporting of the feature information.

20. The method of-claim claim 18, further comprising:
receiving, by the wireless communication device, the processing method corresponding to the first identifier.

21. The method of claim 19, wherein the processing method is available after the receiving of the processing method.

22. The method of claim 1, further comprising:
receiving, by the wireless communication device, a second identifier associated with a processing method or a functionality.

23. The method of claim 22, wherein the second identifier is determined based on the feature information; or
the second identifier is specific to the feature; or
the second identifier is associated with an activation command to activate the processing method or the functionality; or
the second identifier is associated with a switching command for switching from the processing method or the functionality to a different processing method or a different functionality; or
the second identifier is associated with a selection command for selecting from other processing methods or from other supported functionalities that are able to be activated; or
the second identifier is associated with a report setting.

24-28. (canceled)

29. A wireless communications apparatus comprising a processor and a memory, wherein the processor is configured to read code from the memory and implement a method comprising: reporting, by a wireless communication device, feature information for a feature in a user equipment (UE) capability report.

30. (canceled)
